(19) United States
(12) Patent Application Publication
(10) Pub. No.: US 2026/0287000 A1
(43) Pub. Date: Sep. 24, 2026

(54) METHOD FOR CONNECTING A METAL HOUSING AND A PLASTIC COVER, AND METAL HOUSING COMPRISING A PLASTIC COVER

(71) Applicant: Schaeffler Technologies AG & Co. KG, Herzogenaurach (DE)

(72) Inventors: Jean-Georges Friedmann, Hatten (FR); Marc Beyer, Haguenau (FR); Pascal Verbücheln, Bühl (DE)

(73) Assignee: Schaeffler Technologies AG & Co. KG, Herzogenaurach (DE)

(21) Appl. No.: 18/874,102

(22) PCT Filed: Jun. 2, 2023
(86) PCT No.: PCT/DE2023/100417

§ 371 Date: Dec. 12, 2024

(30) Foreign Application Priority Data
Jul. 1, 2022 (DE) 10 2022 116 452.7

(51) Int. Cl. F16B 17/00; H02K 5/04; H02K 15/14

(52) U.S. Cl. CPC F16B 17/004; H02K 5/04; H02K 15/14

(57) ABSTRACT

The disclosure relates to a method for connecting a metal housing and a plastic cover. A metal ring having a shoulder that extends in a peripheral direction is at least partly overmolded with a plastic material to form the plastic cover. The plastic cover is pushed axially with the metal ring into the metal housing so that the metal ring is located on a periphery of the metal housing. The metal housing is plastically deformed by the application of force so that the metal housing penetrates a recess formed by the shoulder on the metal ring. The disclosure also relates to a metal housing having a plastic cover, and a metal ring is at least in part located between the metal housing and the plastic cover and the metal ring has a shoulder extending peripherally and forms a recess for receiving a plastically deformed region of the metal housing.

### CROSS-REFERENCE TO RELATED APPLICATIONS

This application is the U.S. National Phase of PCT Application No. PCT/DE2023/100417 filed on Jun. 2, 2023, which claims priority to DE 10 2022 116 452.7 filed on Jul. 1, 2022, the entire disclosures of which are incorporated by reference herein.

### TECHNICAL FIELD

The disclosure relates to a method for connecting a metal housing and a plastic cover. The disclosure further relates to a metal housing having a plastic cover.

### BACKGROUND

As a rule, metal housings and plastic covers are screwed together or joined in such a way that form-fitting elements on the metal housing and the plastic cover interact. However, a connection using form-fitting elements is disadvantageous due to the different materials of metal and plastic and can lead to a reduced holding force.

DE 10 2020 131 326 A1 discloses an electric motor for driving an actuating device of a motor vehicle. The electric motor has a housing with a housing base body and a plug module which forms a housing wall of the housing and, together with the housing base body, encloses an interior space. The plug module has a connector which is located outside the interior. Furthermore, a screw having a screw head is provided, by means of which the plug module is fastened to the housing base body, and the screw is arranged completely within the interior.

### SUMMARY

The object of the present disclosure is to provide an alternative method for connecting a metal housing and a plastic cover as well as an alternative metal housing with a plastic cover. In particular, the connection of the metal housing and the plastic cover should have a high holding force and be particularly durable.

According to a method of the disclosure for connecting a metal housing and a plastic cover, the metal housing is provided, substantially made from a metal material. A metal ring having a shoulder that extends at least in part in the peripheral direction is at least partly overmolded with a plastic material in order to form the plastic cover. The plastic cover is pushed axially into the metal housing so that the metal ring is located on at least part of the periphery of the metal housing. The metal housing is plastically deformed by the application of force in such a way that the metal housing at least in part penetrates a recess formed by the shoulder on the metal ring.

In other words, the cylindrical metal ring has a shoulder, and the shoulder is designed as a recess towards the metal housing, i.e., is spaced apart from the metal housing in such a way that a groove-shaped cavity is formed spatially between the shoulder on the metal ring and the metal housing.

The connection between the metal ring and the plastic is form-fitting because the metal ring is at least partially or completely overmolded with plastic material. Furthermore, the connection between the metal ring and the metal housing is at least form-fitting, because the force acting on the metal housing causes the metal housing to be plastically deformed in such a way that the metal housing at least partially penetrates into the groove-shaped recess on the metal ring formed by the shoulder, i.e., the cavity between the metal ring and the metal housing.

The metal ring between the metal housing and the plastic cover creates a particularly durable connection between the metal housing and the plastic cover and has a high holding force. Furthermore, the metal ring reliably prevents damage to the plastic cover. In an example embodiment, the metal housing and/or the metal ring are formed from a steel alloy. For example, the metal housing and the metal ring are formed from the same material and therefore have identical material properties.

The axial insertion of the plastic cover into the metal housing means that the plastic cover and the metal housing are axially displaced relative to each other, i.e., either the two components are moved towards each other or at least one of the two components is moved in the direction of the other component. Therefore, it makes no difference whether the plastic cover is pushed axially into the metal housing or the metal housing is pushed axially onto the plastic cover. In particular, the metal housing and the plastic cover are cylindrical.

In an example embodiment, the metal housing and the plastic cover are connected by caulking the metal housing and the metal ring. By caulking, a force-fitting and form-fitting connection is created between the metal housing and the metal ring by plastically deforming at least the metal housing, in particular exclusively the metal housing. For example, the metal housing is plastically deformed by the application of force at designated embossing points in such a way that part of the metal housing is displaced into the groove-shaped cavity between the metal ring and the metal housing and comes into force-fitting contact with the side walls of the cavity, i.e., on the shoulder of the metal ring. For example, the force is applied to an outer peripheral surface of the metal housing in a radially inward direction, so that an elevation is formed on an inner peripheral surface of the metal housing in a radially inward direction, and this elevation engages in a form-fitting and force-fitting manner in the recess created by the shoulder of the metal ring.

In an example embodiment, the at least partially peripheral shoulder on the metal ring is formed by deforming the metal ring. In particular, the metal ring is formed from a steel sheet or a steel tube, and the at least partially peripheral shoulder on the metal ring can be formed by cold forming. For example, the shoulder on the metal ring is completely peripheral. Alternatively, a plurality of shoulders are arranged spaced apart from each other in the peripheral direction and/or in the axial direction.

According to an example embodiment, the shoulder formed as an elevation on the inner peripheral surface of the metal ring is completely overmolded with plastic material. Thus, the elevation extending radially inwards is completely surrounded by plastic material and is thus form-fittingly connected to the plastic material. In an example embodiment, the groove-shaped recess formed on the outer peripheral surface, which is created by the shoulder, is free of plastic material.

For example, the shoulder on the metal ring has a rectangular, semicircular, elliptical or trapezoidal cross-section that is open on one side, such that this cross-section is open towards the metal housing, thereby forming the recess. In particular, the recess formed by the shoulder is groove-shaped around the outer peripheral surface of the metal ring.

In an example embodiment, the metal housing is pressed in at least in sections in the radial direction, in particular locally restricted, on an outer peripheral surface in order to penetrate at least partially radially into the recess formed by the shoulder on the metal ring. For example, the metal housing is pressed in all around the outer peripheral surface or in several areas limited in the peripheral direction, particularly in at least three areas evenly spaced apart in the peripheral direction, so that the metal housing is plastically deformed only in these areas.

In an example embodiment, the plastic cover is pushed axially into the metal housing up to a shoulder formed in the metal housing. Thus, a shoulder is formed on an inner peripheral surface of the metal housing, so that this reduction in the inner diameter in the metal housing forms an axial stop for the plastic cover. This ensures precise positioning of the metal housing and plastic cover during assembly. For example, the metal ring of the plastic cover rests on the shoulder in the metal housing at the front. Furthermore, the connection of the metal housing and the plastic cover is simplified by the plastic deformation of the metal housing.

A metal housing according to the disclosure with a plastic cover has a metal ring which is arranged at least partially between the metal housing and the plastic cover. The metal ring has a shoulder that extends at least in part peripherally, so that the shoulder forms a recess for receiving an at least partially plastically deformed region of the metal housing. Thus, the recess formed by the shoulder is formed on a peripheral surface of the metal ring which forms the metal housing. Due to the plastically deformed metal of the metal housing, which has flowed into the recess during the assembly process, the metal housing and the plastic cover are indirectly connected at least in a form-fitting manner via the metal ring.

According to an example embodiment, the metal housing is plastically deformed at least in sections on an outer peripheral surface in the region of the shoulder on the metal ring. This plastic deformation is visible as an indentation in the outer peripheral surface of the metal housing. The metal ring is arranged on the inner peripheral surface of the metal housing, and the material displaced on the outer peripheral surface of the metal housing has penetrated into the recess formed by the shoulder on the metal ring in order to connect the metal housing to the plastic cover.

An electric machine according to the disclosure has a metal housing according to the disclosure with a plastic cover. In particular, the metal housing according to the disclosure with the plastic cover is manufactured according to the method according to the disclosure. For example, the electric machine is intended for a motor vehicle, in particular for driving an actuating device. The plastic cover of the metal housing is designed specifically as a plug module.

### BRIEF DESCRIPTION OF THE DRAWINGS

Further measures to improve the disclosure are shown in more detail below together with the description of an example embodiment of the disclosure based on the figures. In the figures:

FIG. 1 shows a schematic perspective sectional view of a metal ring;

FIG. 2 shows a schematic perspective sectional view of a plastic cover;

FIG. 3 shows a schematic perspective sectional view of a metal housing with the plastic cover according to FIG. 2; and

FIG. 4 shows a schematic perspective sectional view of the metal housing with the plastic cover after formation of the connection.

### DETAILED DESCRIPTION

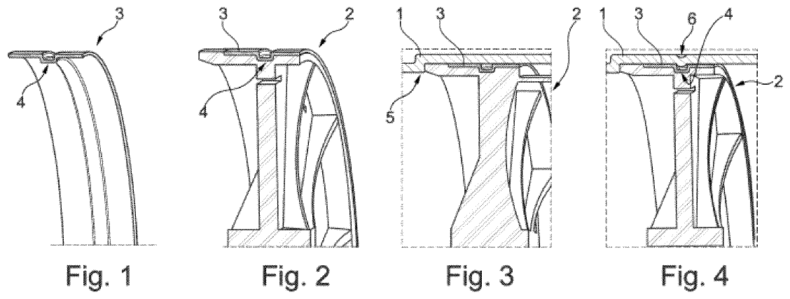

FIGS. 1 to 4 show method steps for connecting a metal housing 1 and a plastic cover 2 by means of a metal ring 3 partially arranged between the metal housing 1 and the plastic cover 2.

According to FIG. 1, the partially shown cylindrical metal ring 3 is manufactured with a shoulder 4 extending in the circumferential or peripheral direction. The shoulder 4 has a substantially trapezoidal cross-section and is formed radially inward on the metal ring 3 in such a way that a circumferential or peripheral groove-shaped recess is formed on the outer peripheral surface (or outer circumferential surface) of the metal ring 3. The shoulder 4 is produced, for example, by cold forming the metal ring 3.

FIG. 2 shows the plastic cover 2, which is produced by overmolding the metal ring 3 shown in FIG. 1 with plastic. In other words, the metal ring 3 is placed in an injection mold and overmolded with the plastic to produce the plastic cover 2. The shoulder 4, which is formed as an elevation on the inner peripheral surface (or inner circumferential surface) of the metal ring 3, is completely overmolded with plastic material. No plastic material is provided on the outer peripheral surface of the metal ring 3.

FIG. 3 shows the plastic cover 2 arranged in the metal housing 1, and the metal ring 3 is arranged with its outer peripheral surface on the inner peripheral surface (or inner circumferential surface) of the metal housing 1. The plastic cover 2, i.e., the metal ring 3 overmolded with plastic, has, for example, a transition fit to the metal housing 1. Alternatively, a clearance or interference fit between the plastic cover 2 and the metal housing 1 is also conceivable. The metal housing 1 has a shoulder 5 on the inner peripheral surface, i.e., a reduction in the inner diameter, and the plastic cover 2 is pushed axially into the metal housing 1 up to the shoulder 5 formed in the metal housing 1. Thus, the shoulder 5 in the metal housing 1 serves as an axial stop surface for positioning the plastic cover 2 in the metal housing 1.

FIG. 4 shows the metal housing 1 with the plastic cover 2 in the connected state, i.e., after caulking the metal housing 1 and the metal ring 3. In other words, the metal housing 1 was plastically deformed by the application of force to a plurality of embossing points 6 provided for this purpose on the outer peripheral surface in such a way that the metal housing 1 has at least partially penetrated into the recess on the metal ring 3 formed by the shoulder 4. For example, the metal housing 1 and the metal ring 3 are made of the same steel alloy.

### LIST OF REFERENCE SYMBOLS

1 Metal housing
2 Plastic cover
3 Metal ring
4 Shoulder on the metal ring
5 Shoulder in the metal housing
6 Embossing point

1. A method for connecting a metal housing and a plastic cover comprising:
providing the metal housing,
providing a metal ring having a shoulder extending at least in part in a peripheral direction, the metal ring is at least partly overmolded with a plastic material to form the plastic cover,
axially pushing the plastic cover and the metal ring into the metal housing so that the metal ring is located on at least part of a periphery of the metal housing,
plastically deforming the metal housing so that the metal housing penetrates a recess formed by the shoulder on the metal ring.

2. The method according to claim 1, wherein the metal housing and the plastic cover are connected by caulking the metal housing and the metal ring.

3. The method according to claim 1, wherein the shoulder on the metal ring is formed by deforming the metal ring.

4. The method according to claim 1, wherein the shoulder is formed as an elevation on an inner peripheral surface of the metal ring and is completely overmolded with plastic material.

5. The method according to claim 4, wherein the metal housing is pressed in at least in sections in a radial direction on an outer peripheral surface to penetrate at least partially radially into the recess formed by the shoulder on the metal ring.

6. The method according to claim 5, wherein the plastic cover is pushed axially into the metal housing up to a shoulder formed in the metal housing.

7. A housing assembly, comprising:
a metal housing,
a plastic cover fixed to the metal housing,
a metal ring is arranged at least partially between the metal housing and the plastic cover, the metal ring having a shoulder extending at least in part peripherally, the shoulder forming a recess for receiving an at least partially plastically deformed region of the metal.

8. The housing assembly according to claim 7, wherein at least one of the metal housing or the metal ring is formed from a steel alloy.

9. The housing assembly according to claim 7, wherein the metal housing is plastically deformed at least in sections on an outer peripheral surface of the metal housing in a region of the shoulder on the metal ring (3).

10. An electric machine having a metal housing according to claim 7.

11. The method according to claim 5, wherein the recess formed by the shoulder of the metal ring is free of plastic material.

12. The method according to claim 11, wherein the inner peripheral surface of the metal ring and the outer peripheral surface of the metal housing are cylindrical.

13. The method according to claim 6, wherein when the plastic cover is pushed axially into the metal housing up to the shoulder, an outer circumferential surface of the plastic cover and an inner circumferential surface of the metal housing form one of either a transition fit, a clearance fit, or an interference fit.

14. The housing assembly according to claim 9, wherein the recess formed by the shoulder of the metal ring is free of plastic material.

15. A housing assembly, comprising:
a metal housing,
a plastic cover fixed to the metal housing,
a metal sleeve arranged radially between the metal housing and the plastic cover, the metal sleeve:
having a circumferentially extending shoulder forming a recess with the metal housing, the circumferentially extending shoulder overmolded with plastic material of the plastic cover, and
fixedly attached to the metal housing via radially inward elevations that penetrate into the recess to form a force-fitting connection, the radially inward elevations formed via plastic deformation of the metal housing after axial insertion of the plastic cover within the metal housing.

16. The housing assembly according to claim 15, wherein the recess is open on one side before insertion of the plastic cover within the metal housing.

17. The housing assembly of claim 16, wherein the circumferentially extending shoulder is integrally formed with the metal sleeve via a metal forming process.

18. The housing assembly according to claim 17, wherein an outer circumferential surface of the metal sleeve is free of the plastic material of the plastic cover.

19. The housing assembly according to claim 17, wherein the plastic cover is axially inserted within the metal housing until an end of the plastic cover engages a shoulder of the metal housing, the shoulder forming an axial stop for the plastic cover.

20. The housing assembly according to claim 19, wherein the metal housing, plastic cover and metal sleeve are cylindrical in shape.
